(19) United States
(12) Patent Application Publication
(10) Pub. No.: US 2012/0216963 A1
(43) Pub. Date: Aug. 30, 2012

(54) Forced Air Thermal Turbine Evaporation System

(76) Inventor: James Tafoya, Meeker, CO (US)

(21) Appl. No.: 13/035,956

(22) Filed: Feb. 26, 2011

(51) Int. Cl. B01D 1/16

(52) U.S. Cl. 159/4.01; 159/47.3

(57) ABSTRACT

A forced air thermal turbine evaporation system wherein industrial waste water is pumped from a water source through a stainless steel hose to a flow meter, pressure switch and into a distribution header. The water leaves the distribution header through a plurality of spiral nozzles that atomize the water into fine water droplets that are introduced into a turbine exhaust pipe in which the droplets are vaporized and disbursed into the atmosphere.

### BACKGROUND OF THE INVENTION

1. Field of the Invention

The present invention relates generally to water evaporation systems and, more specifically, to a forced air thermal turbine water evaporation system for use in disposing of waste water in the mining, manufacturing, oil & gas and food processing industries. There is one pump that sits at the edge of the water source that pumps to the nozzle array at the evaporator. Each evaporator system has a series of nozzles that disperse the water into the exhaust/air stream. The air/exhaust stream is discharged through a piping system that the water is emitted through the nozzles in small water droplets that are evaporated.

The water evaporation system of the present invention comprises one or more Forced Air Thermal Units (Turbine Evaporators) that are setup near the water source to be evaporated. A 240 volt single phase stainless steel centrifugal pump is set up at the water source to deliver water at a rate of 50 gpm to 400 gpm to the nozzle array at the evaporator. The water is pumped through a stainless steel hose to a flow meter to set the desired flow rate. The water then goes into a distribution header that distributes the water through a stainless steel line to the individual nozzles. The distribution header has a pressure switch for a system shutdown in case the nozzles become plugged by debris. There are 4 to 12 stainless steel spiral wound nozzles per evaporation system depending on the size of the evaporator. The water once it reaches the nozzles is atomized by the spiral nozzles into fine water droplets that are emitted into the air/exhaust stream. The energy source for the Turbine unit is a natural gas, propane, kerosene or diesel turbine. The turbine emits 3 lbs./second to 45 lbs./second of 650 degree F. to 1022 degree F. exhaust depending on the size and fuel specifications of the turbine that is discharge through a 6 inch to 20 inch exhaust pipe depending on the size of the turbine into the atmosphere. The rate of water to exhaust ratio is adjusted by increasing or decreasing the water rate that enters the exhaust stream to achieve the maximum evaporation rate based on humidity.

2. Description of the Prior Art

There are other systems which provide for evaporation of waste water. While these systems may be suitable for the purposes for which they where designed, they would not be as suitable for the purposes of the present invention as heretofore described.

### SUMMARY OF THE PRESENT INVENTION

A primary object of the present invention is to provide a water evaporation system that allows for a greater evaporation rate by utilizing waste heat to form a water/steam vapor to enter the atmosphere

Another object of the present invention is to provide a water evaporation system that provides a 65 to 80% increase in efficiency over conventional evaporation systems.

Yet another object of the present invention is to provide a water evaporation system that reduces the environmental impact due to the fact that there are no large water droplets for the wind to carry outside containment areas since the water leaving the spiral cones are a fine heated vapor and the emissions from the turbine have minimal environmental impact.

Another object of the present invention is to provide a water evaporation system that enhances the ability to evaporate in cold and humid conditions due to the fact that the water and air are heated using the waste heat source.

Yet another object of the present invention is to provide a water evaporation system that is modular and can be customized for size and evaporation needs at each site.

Additional objects of the present invention will appear as the description proceeds.

The present invention overcomes the shortcomings of the prior art by providing a forced air thermal turbine evaporation system wherein industrial waste water is pumped from a water source through a stainless hose to a flow meter, pressure switch and into a distribution header. The water leaves the distribution header through a plurality of spiral nozzles that atomize the water into fine water droplets that are introduced into a turbine exhaust pipe in which the droplets are vaporized and disbursed into the atmosphere.

The foregoing and other objects and advantages will appear from the description to follow. In the description reference is made to the accompanying drawings, which forms a part hereof, and in which is shown by way of illustration specific embodiments in which the invention may be practiced. These embodiments will be described in sufficient detail to enable those skilled in the art to practice the invention, and it is to be understood that other embodiments may be utilized and that structural changes may be made without departing from the scope of the invention. In the accompanying drawings, like reference characters designate the same or similar parts throughout the several views.

The following detailed description is, therefore, not to be taken in a limiting sense, and the scope of the present invention is best defined by the appended claims.

### BRIEF DESCRIPTION OF THE DRAWING FIGURES

In order that the invention may be more fully understood, it will now be described, by way of example, with reference to the accompanying drawing in which:

FIG. 1 is an illustrative view of the present invention.

FIG. 2 is an illustrative view of the assembly of the present invention.

FIG. 3 is a flow chart of the present invention.

FIG. 4 is a flow chart of the present invention.

FIG. 5 is an illustrative view of the turbine evaporator system of the present invention.

FIG. 6 is a top view of the pontoon evaporator system of the present invention.

FIG. 7 is a side view of the pontoon evaporator of the present invention.

FIG. 8 is an illustrative view of the evaporator nozzle of the present invention.

FIG. 9 is a top view of the eductor and stand of the present invention.

FIG. 10 is side view of the eductor and stand of the present invention.

### DESCRIPTION OF THE REFERENCED NUMERALS

Turning now descriptively to the drawings, in which similar reference characters denote similar elements throughout the several views, the figures illustrate the Forced Air Thermal Turbine Evaporator of the present invention. With regard to the reference numerals used, the following numbering is used throughout the various drawing figures.

10 Forced Air Thermal Turbine Evaporator of the Present Invention

11 Thermal Turbine Unit

12 Waste Water

14 Holding Pond

16 Centrifugal Pump

18 Spray Nozzle

20 Turbine

22 Exhaust Pipe of 20

24 Water Intake

26 Braided Stainless Steel Hose

28 Flow Meter

30 Pressure Switch

32 Air/Water Mix Nozzle

34 Distribution Header

36 Pontoon

38 Heat Exchanger

40 Eductor

42 Ross Member

44 Hot Air Inlet

46 Siphon Tube

48 Nozzle Riser

50 Aluminum Block

52 Spiral Outlet

54 Stand

56 Bearing Swivel

58 Base of 54

60 Needle Valve

62 Water Inlet

### DETAILED DESCRIPTION OF THE PREFERRED EMBODIMENT

The following discussion describes in detail one embodiment of the invention (and several variations of that embodiment). This discussion should not be construed, however, as limiting the invention to those particular embodiments, practitioners skilled in the art will recognize numerous other embodiments as well. For definition of the complete scope of the invention, the reader is directed to appended claims.

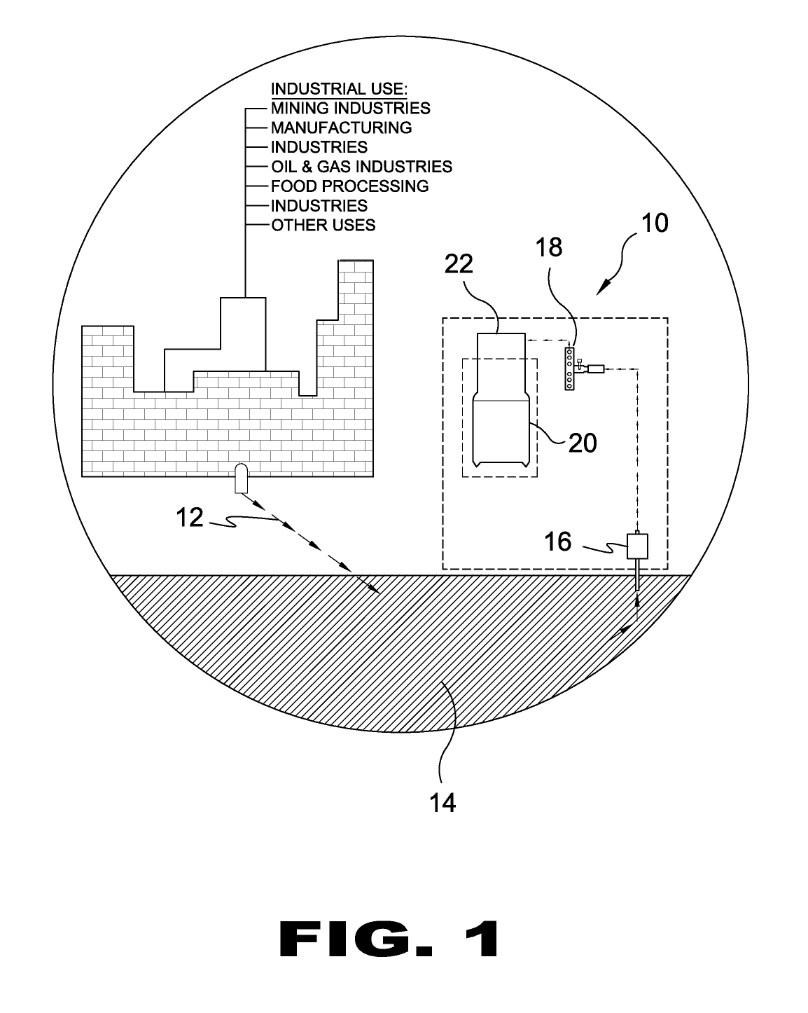

Referring to FIG. 1, shown is an illustrative view of the present invention. The present invention is a forced air thermal waste water evaporation system 10 for use in disposing waste water in mining, manufacturing, oil and gas and food processing industries. Waste water 12 is drawn from a holding pond 14 by a centrifugal pump 16 and delivered by nozzles 32 to the exhaust pipe 22 of a turbine 20 where it is emitted into the atmosphere.

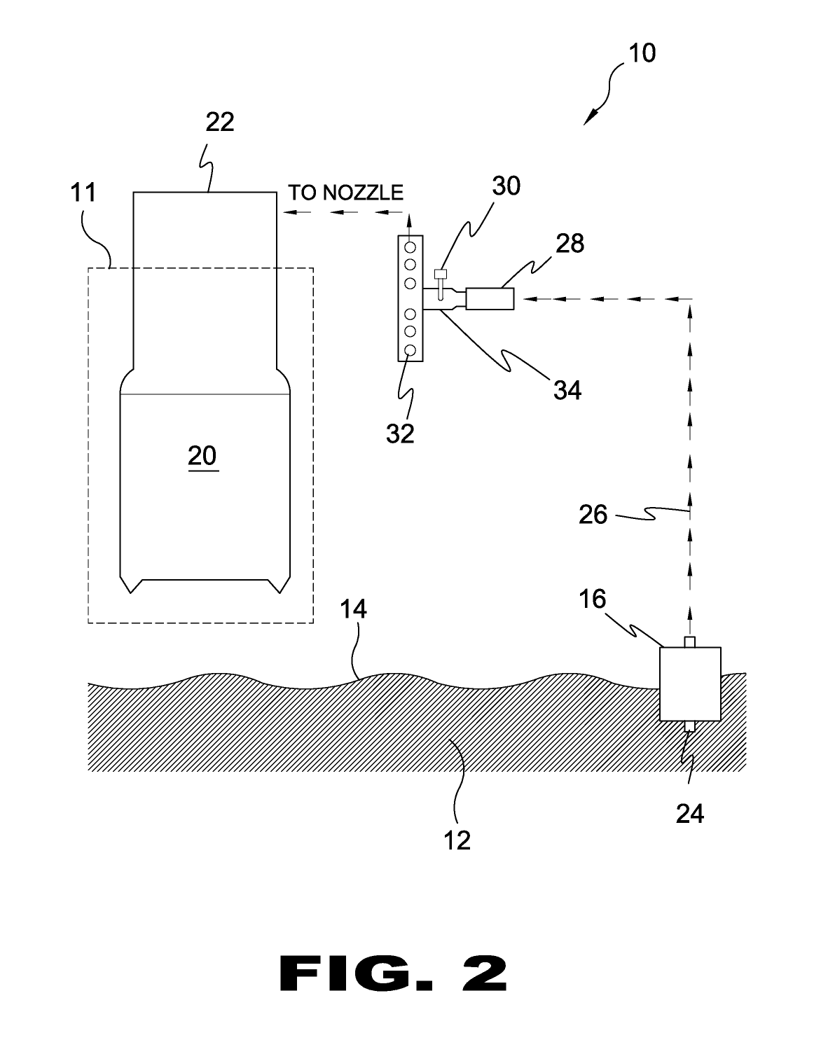

Referring to FIG. 2, shown is an illustrative view of the forced air thermal waste water evaporation system 10 of the present invention. The present invention is a forced air thermal waste water evaporation system 10 wherein one or more forced air thermal units 11 (turbine evaporators) are set up near the water source 14 to be evaporated. A centrifugal pump 16 with water intake 24 is set up at the water source 14 to deliver water 12 to the nozzle array at the evaporator. The water 12 is pumped through a stainless steel hose 26 to a flow meter 28 to set the desired flow rate. The water then goes into a distribution header 34 that distributes the water 12 through the line to the individual spray nozzles 18. The distribution header 34 has a pressure switch 30 for a system shut down in case the nozzles 32 become plugged by debris. Once the water 12 reaches the nozzles 32 it is atomized by the spiral nozzles into fine water droplets that are emitted into the air/exhaust stream. The heat from the exhaust pipe 22 of the turbine 20 evaporates the droplets, sending the vapor into the atmosphere.

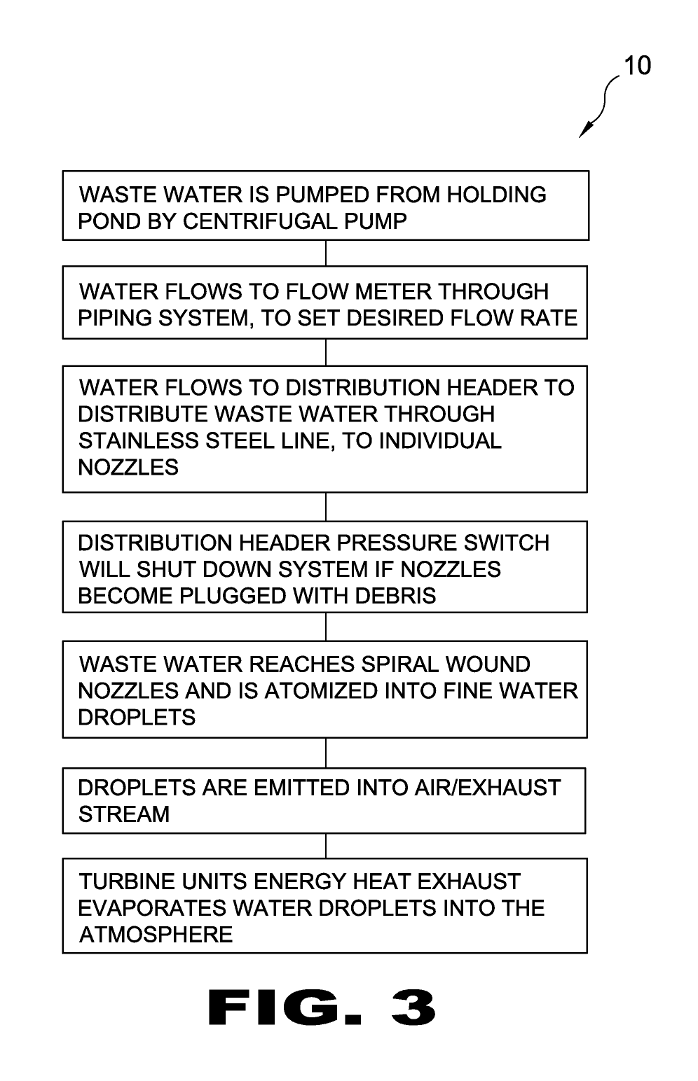

Referring to FIG. 3, shown is a flow chart of the present invention. Shown is a flow chart of the operation of the forced air thermal turbine evaporation system 10.

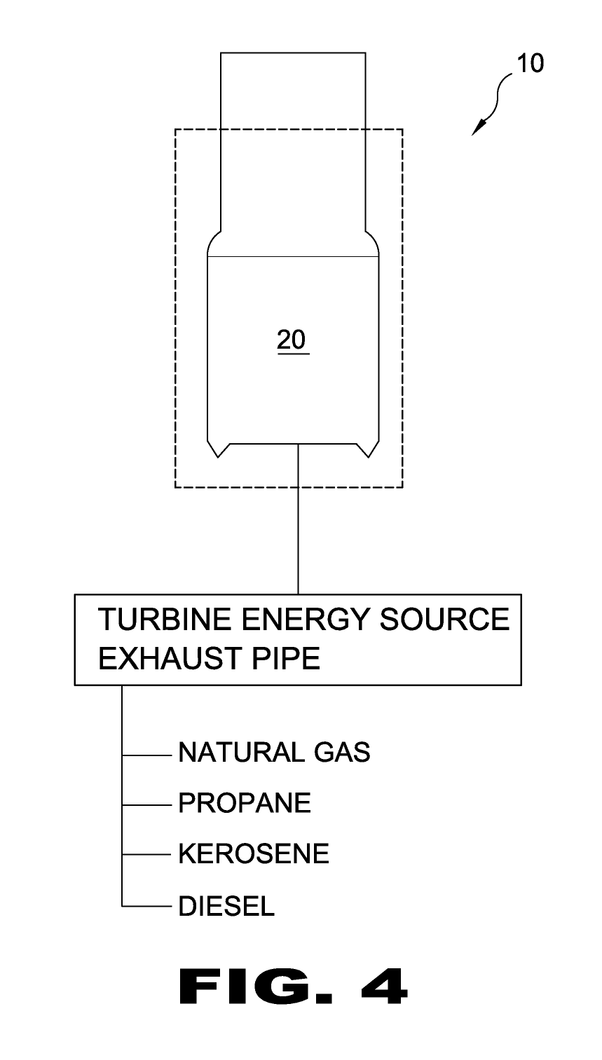

Referring to FIG. 4, shown is a flow chart of the present invention. Shown is a flow chart of the energy sources used by the turbine unit 20 of the forced air thermal turbine evaporation system 10.

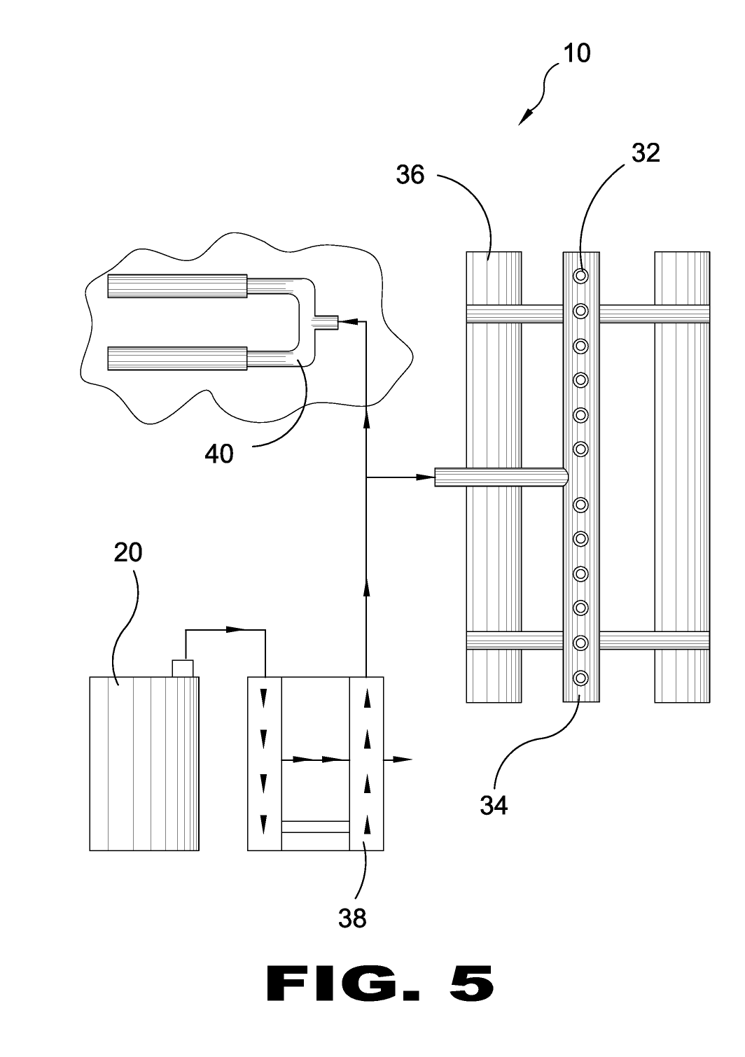

Referring to FIG. 5, shown is an illustrative view of the turbine evaporator system 10 of the present invention. Shown is the turbine evaporator system 10 with the distribution header 34 and its air/water mix nozzles 32 mounted on pontoons 36. Also illustrated are the turbine 20, heat exchanger 38 and eductor 40.

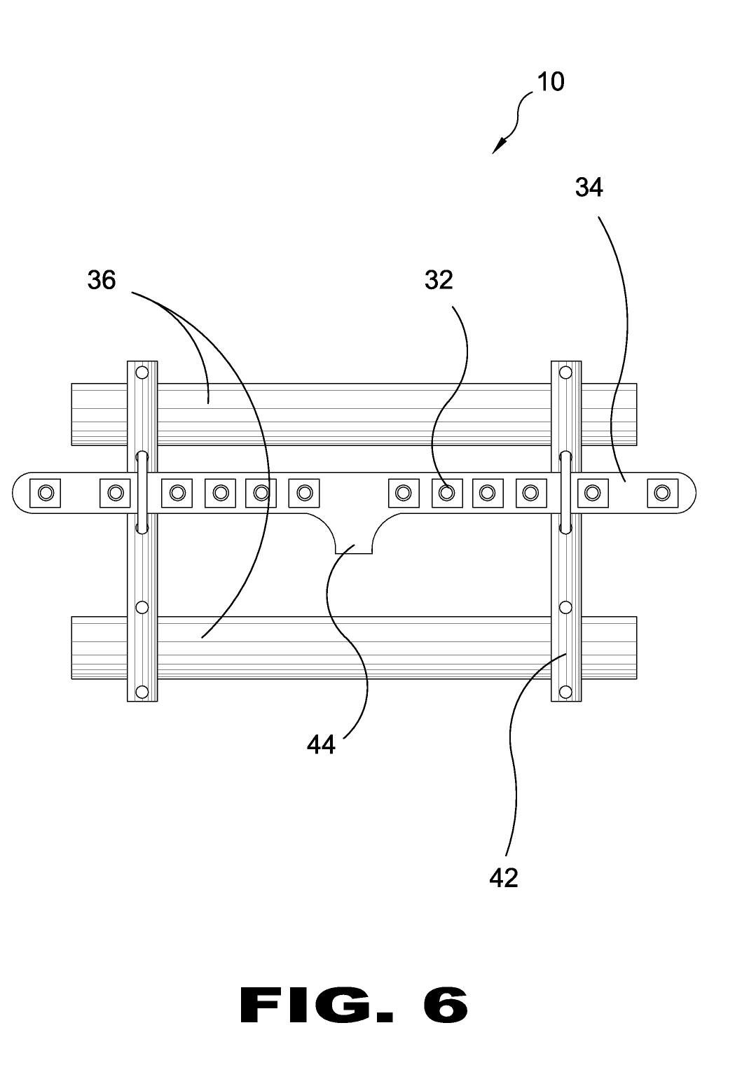

Referring to FIG. 6, shown is a top view of the pontoon 36 based turbine evaporator system 10. Shown is the distribution header 34 and associated air/water mix nozzles 32 supported on pontoons 36 by cross members 42 utilized to float atop a body of water and mix said water with the heat from the heat exchanger through the hot air inlet 44 in order to spray said mixture into the atmosphere.

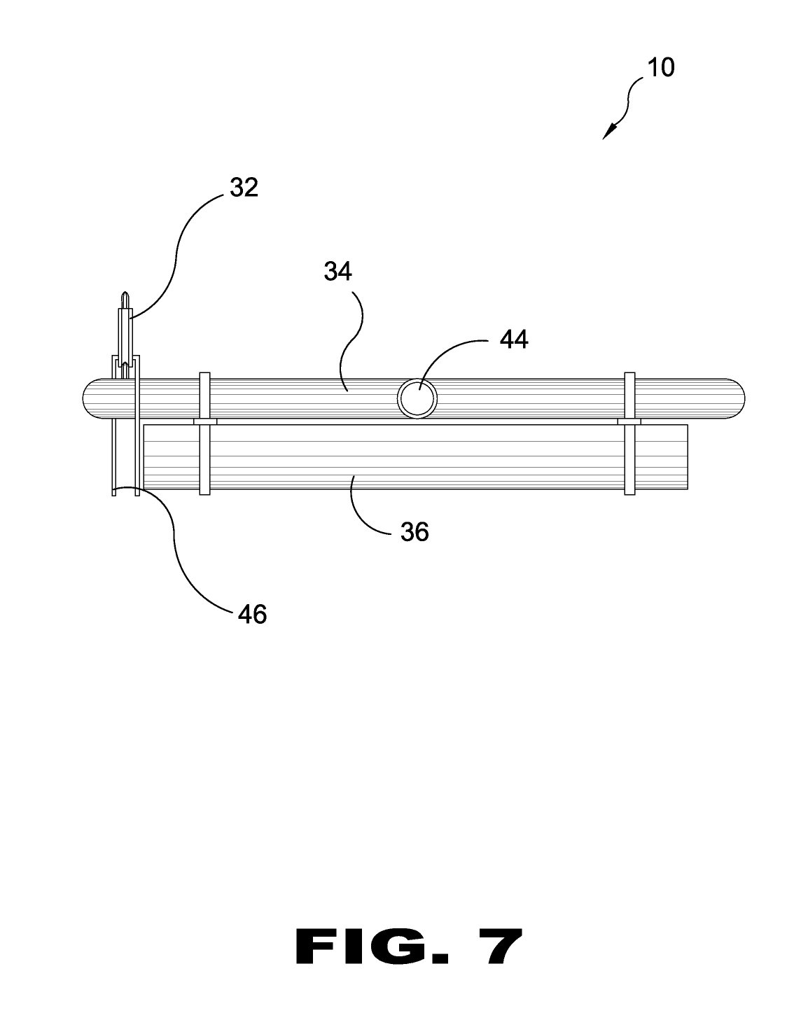

Referring to FIG. 7, shown is a side view of the pontoon 36 based turbine evaporator 10. Shown is the distribution header 34 with air/water mix nozzles 32, a siphon tube 46, hot air inlet 44 and pontoons 36.

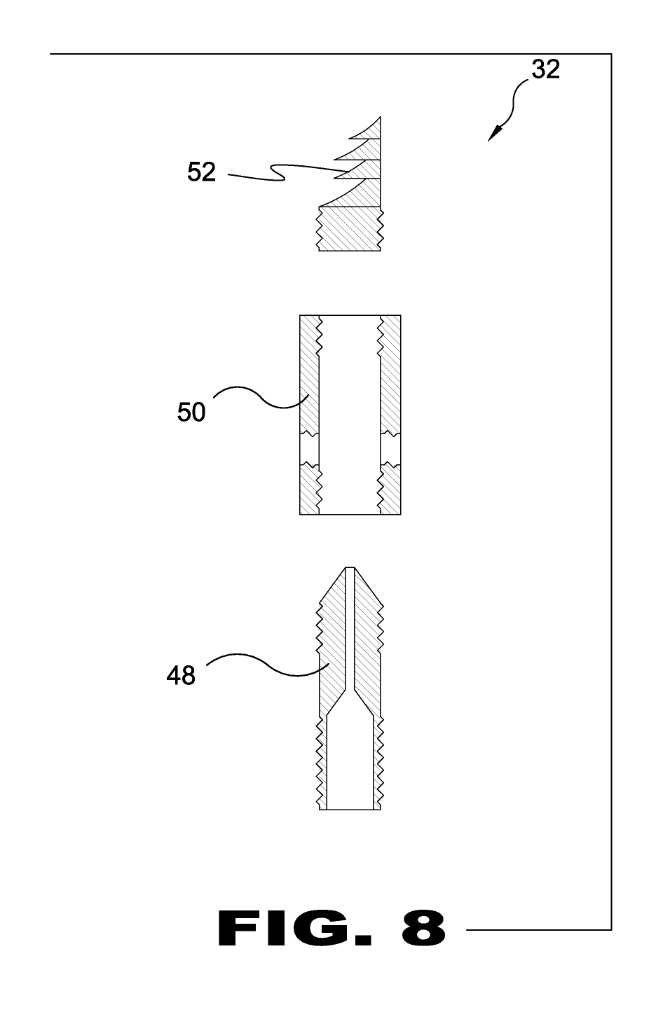

Referring to FIG. 8, shown is an illustrative view of the evaporator nozzle 32 of the present invention. Shown are the basic components of the air/water nozzle 32 of the evaporator including the nozzle riser 48, aluminum block 50 and spiral outlet 52.

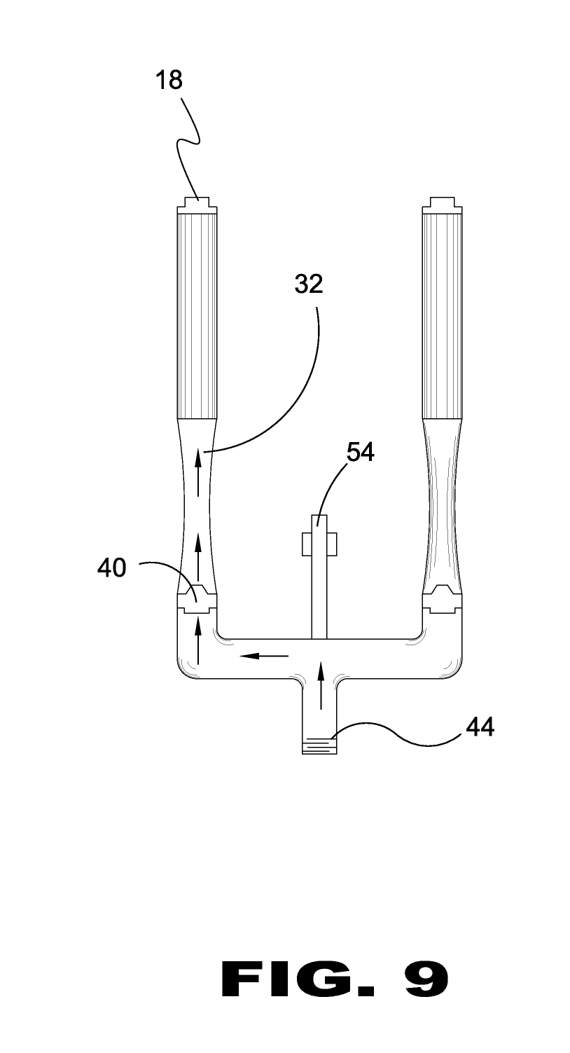

Referring to FIG. 9, shown is a top view of the eductor 40 and stand 54 of the present invention. Shown is the eductor 40 and stand 54 that can be used in a land based or pontoon based evaporator. Also depicted is the hot air inlet 44, air/water mix nozzles 32 and spray nozzle 18.

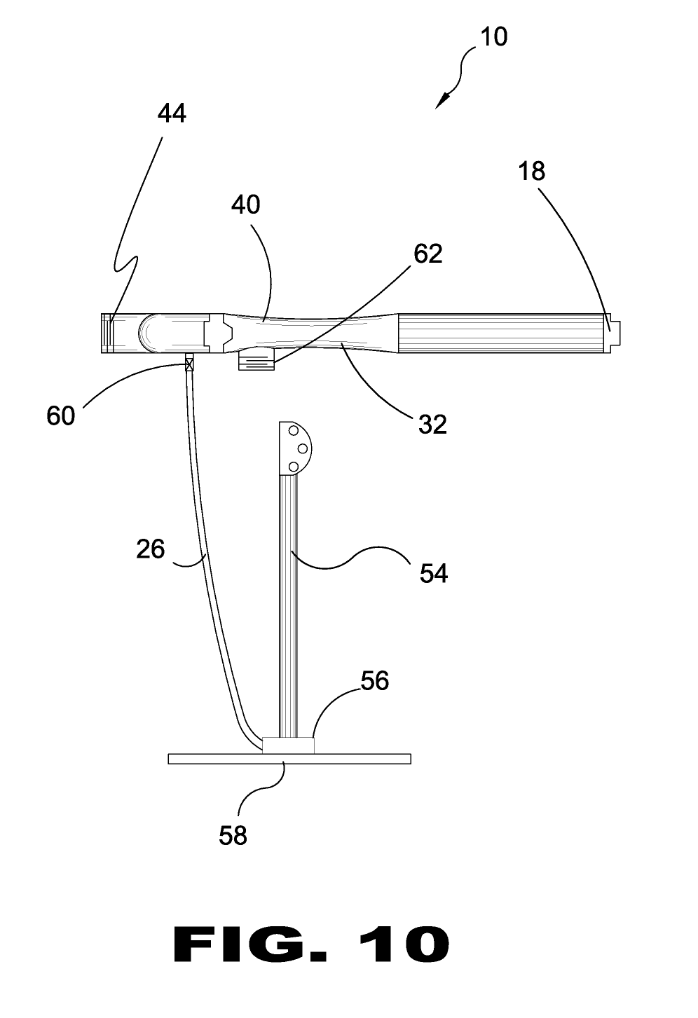

Referring to FIG. 10, shown is side view of the eductor 40 and stand 54 of the turbine evaporator system 10. The stand 54 incorporates a pneumatically driven bearing swivel 56 at its base 58 with a steel braided hose 26 in communication with a needle valve 60 connected to the eductor 40. Also shown are the air inlet 44, water inlet 62 and air/water mix nozzle 32.

It will be understood that each of the elements described above, or two or more together may also find a useful application in other types of methods differing from the type described above.

While certain novel features of this invention have been shown and described and are pointed out in the annexed claims, it is not intended to be limited to the details above, since it will be understood that various omissions, modifications, substitutions and changes in the forms and details of the device illustrated and in its operation can be made by those skilled in the art without departing in any way from the spirit of the present invention.

Without further analysis, the foregoing will so fully reveal the gist of the present invention that others can, by applying current knowledge, readily adapt it for various applications without omitting features that, from the standpoint of prior art, fairly constitute essential characteristics of the generic or specific aspects of this invention.

What is claimed is new and desired to be protected by Letters Patent is set forth in the appended claims:

1. A waste water evaporation system comprising:
a) a pump for drawing waste water from a storage source;
b) a distribution header for atomizing said drawn waste water;
c) a braided stainless steel hose for delivering said waste water to said distribution header from said pump;
d) a thermal turbine evaporation unit having a heated exhaust/air stream that travels through an exhaust pipe into which said atomized waste water is introduced, heated and delivered into the atmosphere.

2. The waste water evaporation system according to claim 1, wherein said distribution header comprises:
a) a flow meter to set the waste water flow at a preselected rate;
b) a nozzle array comprising a plurality of spray nozzles; and
c) a pressure switch for shutting down the pump in the event that said nozzles become plugged by debris.

3. The waste water evaporation system according to claim 2, wherein said spray nozzles are stainless steel spiral wound nozzles.

4. The waste water evaporation system according to claim 3, wherein each said spray nozzle comprises:
a) an aluminum block having a first end and a second end and a central throughbore with interior threads at each end thereof;
b) a nozzle riser having exteriorly disposed threads to mate with said interior threads at said first end of said aluminum block; and
c) a spiral outlet having exteriorly disposed threads to mate with said interior threads at said second end of said aluminum block.

5. The waste water evaporation system according to claim 4, wherein the number of said spray nozzles is within the range of 4-12 according to specification.

6. The waste water evaporation system according to claim 1, wherein the energy source for said turbine is selected from the group natural gas, propane, kerosene and diesel turbine.

7. The waste water evaporation system according to claim 6, wherein said turbine unit emits exhaust within the range of 3 lbs./second to 45 lbs./second and within the temperature range of 650 degrees F. to 1022 degrees F. according to specification.

8. The waste water evaporation system according to claim 7, wherein the size of said exhaust pipe is within the range of 6-20 inches according to specification.

9. The waste water evaporation system according to claim 1, wherein said pump is a centrifugal pump.

10. The waste water evaporation system according to claim 9, wherein said centrifugal pump is a 240 volt single phase stainless steel centrifugal pump.

11. The waste water evaporation system according to claim 10, wherein said centrifugal pump delivers waste water to said nozzle array at a rate within the range of 50 gpm to 400 gpm according to specification.

12. The waste water evaporation system according to claim 1, further comprising an eductor.

13. The waste water evaporation system according to claim 12, wherein said eductor comprises:
a) a hot air inlet;
b) at least two internal air/water mix nozzles;
c) at least two said spray nozzles; and
d) a water inlet.

14. The waste water evaporation system according to claim 13, wherein said system is water based and comprises:
a) a pair of pontoons;
b) at least two cross members spanning the distance between said pontoons for mounting said distribution header thereto; said hot air inlets of said distribution header and said eductor; and
d) a siphon tube related with said distribution header for drawing waste water from said water source to said distribution header.

15. The waste water evaporation system according to claim 13, wherein said system is land based.

16. The waste water evaporation system according to claim 15, wherein said land based system further comprises:
a) a stand for said eductor;
b) a base for said stand;
c) a pneumatically driven bearing swivel for mounting said stand to said base;
d) a needle valve projecting from said eductor;
e) a stainless steel braided hose communicating between said bearing swivel and said needle valve.

17. A method for utilizing a forced air thermal turbine evaporation system to evaporate waste water produced by industry comprising the steps:
a) providing a centrifugal pump with water intake to draw waste water from a holding source and delivering it through the system; a distribution header with a flow meter to set the rate of water flow thereto; a nozzle array having a plurality of spray nozzles; a pressure switch to shut down the pump if water flow through said spray nozzles becomes restricted; a stainless steel braided hose communicating between said centrifugal pump and said distribution header; and a turbine with a heat emitting exhaust pipe utilizing a power source selected from the group natural gas, propane, kerosene and diesel;
b) drawing water from said holding source with said centrifugal pump and delivering it to said nozzle array of said distribution header;
c) controlling the rate of water flow to said distribution header at a preselected rate with said flow meter;
d) atomizing said water into fine water droplets as it passes through said spray nozzles;
e) introducing said water droplets into said heated moving air in said exhaust pipe wherein said water droplets are vaporized; and
f) emitting said vapor into the atmosphere.

18. The method for utilizing a forced air thermal turbine evaporation system according to claim 17, including the step of providing an eductor comprising:
a) a hot air inlet;
b) a water inlet;
c) a pair of air/water mix nozzles for blending hot air obtained by said hot air inlet and water derived from said water inlet; and
d) a pair of spray nozzles.

19. The method for utilizing a forced air thermal turbine evaporation system according to claim 18, including the step of providing a water based system further comprising:
a) a pair of spaced apart pontoons in parallel relation;
b) a pair of spaced apart cross members spanning said pontoons for mounting said distribution header thereon;
c) a siphon tube associated with said distribution header for drawing said waste water therein; and
d) a heat exchanger for delivering heat harvested from said turbine exhaust pipe to said hot air inlets of said distribution header and said eductor.

20. The method for utilizing a forced air thermal turbine evaporation system according to claim 18, including the step of providing a land based system further comprising:
a) a stand for supporting said eductor in an elevated position;
b) a base for said stand;
c) a pneumatically driven bearing swivel for mounting said stand to said base;
d) a needle valve incorporated with said eductor; and
e) a stainless steel braided hose communicating with said bearing swivel and said needle valve.
